(19) United States
(12) Patent Application Publication
(10) Pub. No.: US 2024/0360709 A1
(43) Pub. Date: Oct. 31, 2024

(54) CABINET LOCK

(71) Applicant: Dorel Juvenile Group, Inc., Foxboro, MA (US)

(72) Inventor: Gaetano D. DESIMONE, Mansfield, MA (US)

(21) Appl. No.: 18/647,016

(22) Filed: Apr. 26, 2024

Related U.S. Application Data
(60) Provisional application No. 63/462,184, filed on Apr. 26, 2023.

(51) Int. Cl. E05C 3/14; E05B 65/00; E05C 3/00

(52) U.S. Cl. CPC E05C 3/14; E05B 65/0014; E05C 3/008

(57) ABSTRACT

A cabinet lock includes a cabinet-door latch and a cabinet-door catch. The cabinet-door latch is configured to be fixed to a cabinet panel for movement with the cabinet panel between a closed position blocking access to a cabinet opening and an opened position exposing the cabinet opening. The cabinet-door catch is configured to engage selectively with the cabinet-door latch to block the cabinet panel from moving from the closed position to the opened position.

### PRIORITY CLAIM

This application claims priority under 35 U.S.C. § 119 (e) to U.S. Provisional Patent Application No. 63/462,184, filed Apr. 26, 2023, which is expressly incorporated by reference herein in its entirety.

### BACKGROUND

The present disclosure relates to a child safety device, and particularly to a child access-restricting device. More particularly, the present disclosure relates to a cabinet and drawer access-restricting device.

### SUMMARY

According to the present disclosure, a cabinet lock for a cabinet or a drawer includes a cabinet-door latch and a cabinet-door catch. The cabinet-door latch is configured to be fixed to a cabinet panel for movement with the cabinet panel between a closed position blocking access to a cabinet opening and an opened position exposing the cabinet opening. The cabinet-door catch is configured to be attached to a cabinet frame bordering the cabinet opening that is closed by the cabinet panel. The cabinet-door latch engages selectively with the cabinet-door catch to block movement of the cabinet panel from the closed position to the opened position to control unauthorized access to an interior of the cabinet.

In illustrative embodiments, the cabinet-door catch includes a catch body, an adhesive layer coupled to the catch body, and a catch lip coupled to the catch body. The adhesive layer is configured to secure the cabinet-door catch to the cabinet frame. The catch lip is coupled to an opposite side of the catch body to engage selectively with the cabinet-door latch when the cabinet panel is closed. The catch body includes an integrated hinge to allow the cabinet-door catch to conform to structures of multiple cabinet frames to maximize contact area between the adhesive layer and the cabinet frame for increased shear resistance to pull-out forces acting on the cabinet-door catch by the cabinet-door latch

In illustrative embodiments, the catch body includes a first body panel coupled to the catch lip, a second body panel spaced apart from the first body panel and the catch lip, and the hinge interconnecting the first body panel and the second body panel of the catch body. The hinge allows the catch body to bend so that the cabinet-door catch can be attached to a first cabinet frame in a first configuration and in a second configuration to a second cabinet frame. In the first configuration, the first and second body panels of the catch body extend along a common plane and parallel to one another. In the second configuration, the catch body is bent about the hinge so that the first and second body panels of the catch body are arranged to lie along respective planes at an angle to one another. The cabinet-door catch can attach to cabinet frames with a lip in the second configuration and to cabinet frames without lips in the first configuration.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a side elevation and diagrammatic view of a cabinet and drawer lock installed on a cabinet having a cabinet frame and a cabinet panel configured to open and close relative to the cabinet frame to control access to an interior of the cabinet, and showing that the cabinet frame includes a top wall having a lower surface extending substantially horizontally, and the cabinet and door lock includes a cabinet-door latch mounted to the cabinet panel and a cabinet-door catch mounted to the lower surface of the top wall in a first installation configuration to selectively engage with the cabinet-door latch when the cabinet panel is closed to block opening of the cabinet panel;

FIG. 2 is a side elevation and diagrammatic view of the cabinet lock installed on a second cabinet having a cabinet frame with a top wall and a frame lip extending downwardly from a lower surface of the top wall, and showing that the cabinet-door catch includes an integrated hinge so that the cabinet-door catch can be bent about the hinge and attached to both a lower surface of the frame lip and a rearward-facing surface of the frame lip in a second attachment configuration to maximize attachment surface area of the cabinet-door catch to the frame lip of the cabinet frame and resistance to shear forces acting on the cabinet-door catch by the cabinet-door latch;

FIG. 3 is a bottom plane view of the cabinet-door catch showing that the cabinet door catch includes a catch body having a first body panel, a second body panel, and the hinge coupled between the first and second body panels, and showing that the cabinet-door catch further includes a catch lip coupled to the first body panel and configured to engage with the cabinet-door latch when the cabinet panel is closed to block opening of the cabinet panel;

FIG. 4 is a side elevation view of the cabinet-door catch showing that the cabinet-door catch further includes an adhesive layer having a first adhesive panel coupled to the first body panel and a second adhesive panel coupled to the second body panel;

FIG. 5 is a perspective view of the cabinet-door catch showing that the catch lip extends away from the catch body and from the adhesive layer and is formed to include a recess that receives a portion of the cabinet-door latch to block separation of the cabinet-door latch from the cabinet-door catch;

FIG. 6 is a perspective view of the cabinet-door latch including a latch body configured to mount to the cabinet panel, a latch arm coupled to the latch body and configured to engage selectively with the cabinet-door catch to block opening of the cabinet panel, and a pair of alignment guides coupled to the latch body and pivotable relative to the latch body from an installation position for installing the cabinet-door latch on the cabinet panel, as shown in FIG. 6, and a use position stowed away after installation of the cabinet-door panel is complete;

FIG. 7 is a perspective view of the cabinet-door latch with the alignment guides pivoted to the use position; and

FIG. 8 is a perspective view of another cabinet-door catch, in accordance with the present disclosure, that can be used with the cabinet-door latch shown in FIGS. 1-7.

### DETAILED DESCRIPTION

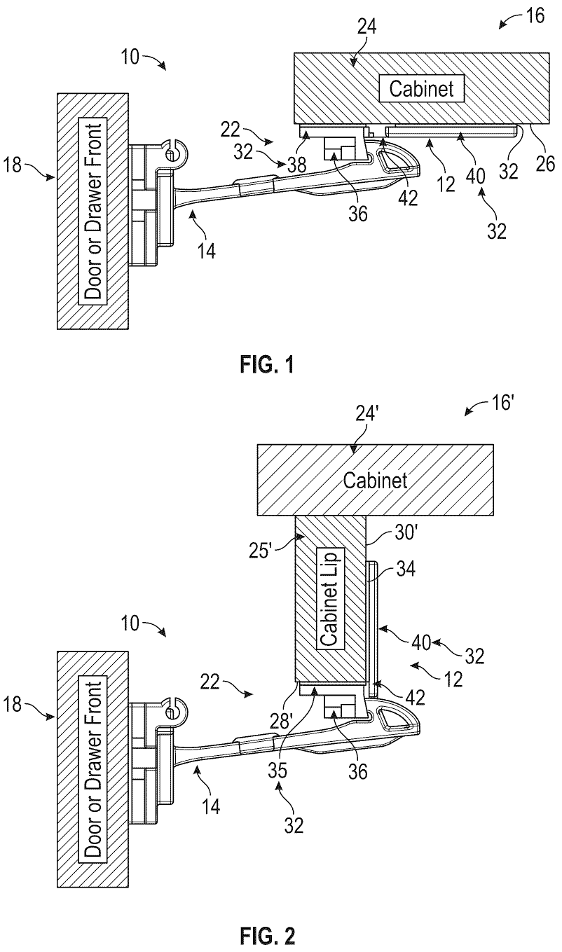

A cabinet and drawer lock 10 includes a cabinet-door catch 12 configured to be attached to a cabinet frame 16, 16′ and a cabinet-door latch 14 configured to be fixed to a cabinet door or drawer 18 (also called a cabinet panel) as shown in FIGS. 1 and 2. The cabinet-door latch 14 is configured to engage the cabinet-door catch 12 when the cabinet door 18 is closed to block the cabinet door 18 from opening. The cabinet-door catch 12 includes an integrated hinge 42 allowing the cabinet-door catch 12 to bend about the hinge 42 so that the cabinet-door catch 12 is installable on different cabinet 16, 16′ types while maximizing resistance to shear and pull-out forces experienced by the cabinet-door catch 12 during use.

The hinge 42 divides the cabinet-door catch 12 into at least two portions so that the cabinet-door catch 12 can be mounted to a lipless cabinet frame 16, as shown in FIG. 1, and to a lipped cabinet frame 16′, as shown in FIG. 2. The lipless cabinet frame 16 includes a top wall 24 partially defining an opening 22 into an interior of the cabinet frame 16. The lipped cabinet frame 16′ also includes a top wall 24′ but further includes a lip 25′ extending downwardly away from the top wall 24′ to partially define an opening 22′ into an interior of the lipped cabinet 16′. The lipless cabinet frame 16 does not include a lip. The hinge 42 allows the cabinet-door catch 12 to bend about the hinge 42 between a first configuration, as shown in FIG. 1, and a second configuration, as shown in FIG. 2.

In the first configuration, the cabinet-door catch 12 is configured to attach to a downward-facing surface 26 of a top wall 24 and establish an attachment interface with the downward-facing surface 26 along a common plane 100 as shown in FIG. 1. The cabinet-door catch 12 is mounted solely to the downward-facing surface 26 of the top wall 24 in the first configuration.

Because the top wall 24 has a depth greater than a total length 61 of the cabinet-door catch 12 in the first configuration, contact provided by the attachment interface between the cabinet-door catch 12 and the cabinet frame 16 is increased to increase shear force resistance. In the illustrative embodiment, the length 61 of the cabinet-door catch 12 in the first configuration is at least 1.5 inches to provide sufficient shear force resistance without the use of fasteners. Other comparable catches have a length that is less than 1.5 inches and have correspondingly lower shear resistance absent fasteners. The cabinet-door catch 12 may also be mounted to a sidewall or a bottom wall of the cabinet frame 12 in the first configuration. The cabinet-door catch 12 is configured to meet design criteria for ASTM F3492 and can resist a predetermined pull-out force of at least 45.3 lbf (20.6 kgf).

In some embodiments, the total length 61 of the cabinet-door catch 12 is at least 1.6 inches. In some embodiments, the total length 61 of the cabinet-door catch 12 is at least 1.7 inches. In some embodiments, the total length 61 of the cabinet-door catch 12 is at least 1.8 inches. In some embodiments, the total length 61 of the cabinet-door catch 12 is at least 1.9 inches. In some embodiments, the total length 61 of the cabinet-door catch 12 is at least 2 inches.

In the second configuration, the cabinet-door catch 12 is bent about the hinge 42 to conform to the structure of the lip 25′ as shown in FIG. 2. In the second configuration, a first portion of the cabinet-door catch 12 is coupled to a downward-facing surface 28′ of the cabinet lip 25′ along a first plane 102 and a second portion of the cabinet-door catch 12 is coupled to a rearward-facing surface 30′ of the cabinet lip 25′ along a second plane 104. In the illustrative embodiment, the first and second planes 102, 104 are perpendicular to one another due to the structure of the lip 25′, however, it should be appreciated that planes 102, 103 may be arranged at a different angle to one another depending on the structure of the lip 25′.

The cabinet-door catch 12 establishes an attachment interface with the lip 25′ along the first plane 102 and the second plane 104 to maximize shear resistance in the second configuration. Other comparable catches may only attach to either the downward-facing surface 28′ or the rearward-facing surface 30′ of the lip 25′ and have less shear resistance than the cabinet-door catch 12 in the second configuration. The cabinet-door catch 12 may also be mounted to a lip extending from a sidewall or a bottom wall of the cabinet frame 12 in the second configuration.

In the illustrative embodiment, the cabinet-door catch 12 includes a catch body 32, an adhesive layer 34 coupled to the catch body 32 and configured to secure the cabinet-door catch 12 to the cabinet frame 16, 16′, and a catch lip 36 coupled to the catch body 32 and configured to engage selectively with the cabinet-door latch 14 when the cabinet door 18 is closed as shown in FIGS. 1-5. The catch body 32 rigidly supports the adhesive layer 34 and the catch lip 36 and allows the cabinet-door catch 12 to change between the first configuration and the second configuration. The adhesive layer 34 may include a pressure-sensitive adhesive to bond with the cabinet frame 16, 16′ when pressed into contact with the cabinet frame 16, 16′. The catch lip 36 is coupled to an opposite side of the catch body 32 from the adhesive layer 34 and extends away from the catch body 32 to interact with the cabinet-door latch 14 when the cabinet panel is closed.

The catch body 32 includes a first body panel 38, a second body panel 40, and the hinge 42 interconnecting the body panels 38, 40 as shown in FIGS. 1-5. The first and second body panels 38, 40 are normally arranged along the common plane 100 in the first configuration. The first and second body panels 38, 40 can be reoriented relative to one another by folding the catch body 32 about the hinge 42. In some embodiments, one or both of the first body panel 38 and the second body panel 40 can include additional hinge(s) 42′ to allow the first body panel 38 and/or the second body panel 40 to bend in addition to hinge 42 to accommodate other structures of the cabinet frame 16.

The cabinet-door latch 14 is biased to engage normally the cabinet-door catch 12 when the cabinet door 18 is closed. The cabinet-door latch 14 may be separated from the cabinet-door catch 12 upon application of a force on the cabinet-door latch 14 which moves at least a portion of the cabinet-door latch 14 away from the cabinet-door catch 12 so that the cabinet door 18 is free to be opened. The force may be imparted directly on the cabinet-door latch 14 by a user or from an intermediate device, such as a magnet, for example.

The cabinet lock 10 of the present disclosure is designed to adhere to a variety of cabinet designs and meet certain safety standards. Specifically, the cabinet lock 10 includes a cabinet-door catch 12 that is adjustable to fit the shape of a variety of cabinet designs as described above while increasing the area of adhesion by conforming to the structure of multiple cabinet types. In some embodiments, the cabinet-door catch 12 is formed without any through holes that would normally be used to install the cabinet-door catch to the cabinet frame using fasteners for increased strength. Instead, the cabinet-door catch 12 can be reconfigured to maximize contact between the adhesive layer 34 and the cabinet frame 16, 16′ so that the use of fasteners can be avoided. This improves shear resistance without fasteners so that the integrity of the cabinet frame 16, 16′ can be preserved.

The adhesive layer 43 includes a first adhesive section 34A and a second adhesive section 34B as shown in FIGS. 1-5. The first body panel 38 is coupled to the catch lip 36 and the first adhesive section 34A of the adhesive layer 34. The second body panel 40 is spaced apart from the first body panel 38 and is coupled to the second adhesive section 34B of the adhesive layer 34. The hinge 42, also referred to as a living hinge 42, allows for the body panels 38, 40 and the adhesive sections 34A, 34B to be adjusted or posed and installed in multiple directions in the first configuration, the second configuration or another configuration depending on the cabinet frame 16, 16′ structure.

The first section 34A of the adhesive layer 34 and/or the first body panel 38 may be sized to have a first length 60 as shown in FIGS. 1-5. The second section 34B of the adhesive layer 34 and/or the second body panel 40 may be sized to have a second length 62 greater than the first length 60. The first and second lengths 60, 62 combined are substantially equal to the total length 61 except that the hinge 42 may provide the total length with a slightly greater dimension than the combination of lengths 60, 62.

In the illustrative embodiment, the first length 60 is less than or equal to a thickness of the lip 25′. Typical cabinet lips, such as lip 25′, have a standard thickness of about 0.6 inches and a standard height of at least 1.3 inches. In some embodiments, the first length 60 has a maximum length of 0.6 inches so that no portion of the first section 34A or the first body panel 38 extends beyond the thickness of the lip 25′. In some embodiments, the second length 62 may have a minimum length of 1.3 inches to maximize contact with available space along rearward-facing surface 30′ of the lip 25′ in the second configuration and along downward-facing surface 26 of the top wall 24 in the first configuration. In other embodiments, the first length 60 may be less than or greater than 0.6 inches and the second length 62 may be less than or greater than 1.3 inches.

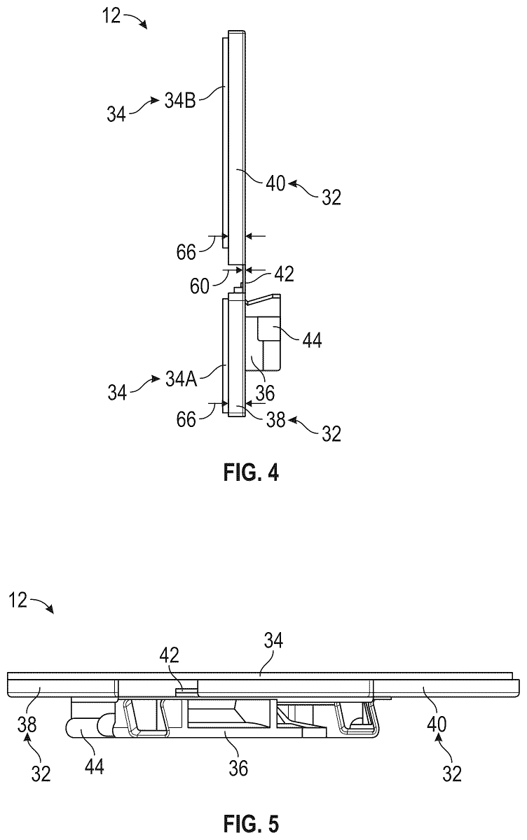

The first and second panels each include a first thickness 66 and the hinge 42 includes a second thickness 68 less than the first thickness as shown in FIG. 4. The reduction in thickness of the hinge 42 provides a predetermined bend line for the catch body 32. The first panel 38 has a first width 70 and the second panel 40 has a second width 72 less than the first width 70. The reduction in width of the second panel 40 relative to the first panel 38 reduces materials used to form cabinet-door catch 12.

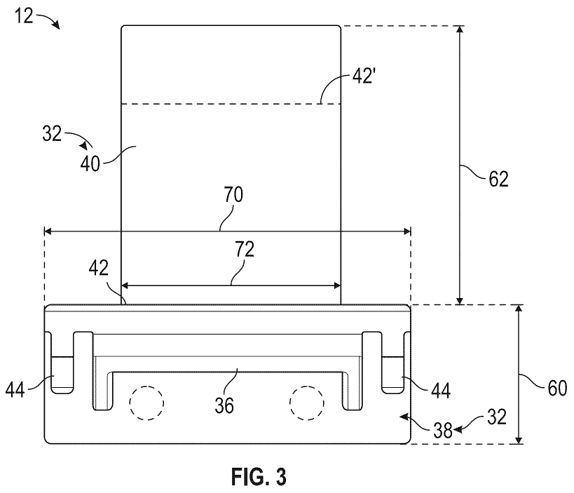

The cabinet-door catch 12 may further include one or more alignment tabs 44 configured to engage electively with the cabinet-door latch 14 during installation of the cabinet lock 10 as shown in FIGS. 3-5. The one or more alignment tabs 44 are coupled to the first body panel 38 and extend away from the hinge 42 in a forward direction and parallel to the first body panel 38.

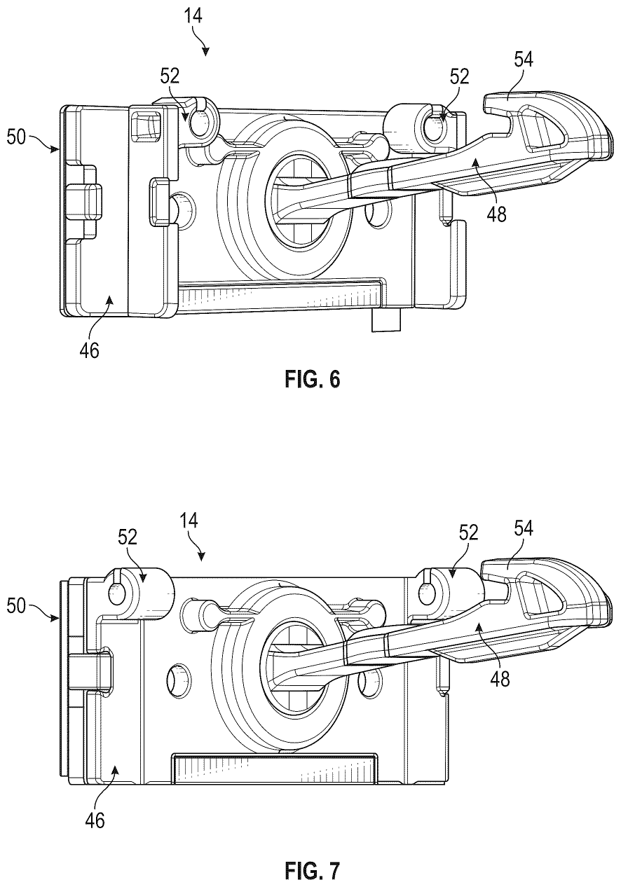

The cabinet-door latch 14 is configured to attach to the cabinet door 18 and engage with the cabinet-door catch 12 during and after installation of the cabinet lock 10 shown as shown in FIGS. 6-7. The cabinet-door latch 14 includes a latch body 46, a latch arm 48 coupled to and extending from the latch body 46, an adhesive layer 50 coupled to the latch body 46 and configured to secure the cabinet-door latch 14 to the cabinet door 18, and one or more alignment guides 52 coupled to the latch body 46 and configured to engage with the cabinet-door catch 12 during installation of the cabinet lock 10.

The latch arm 48 extends generally perpendicular relative to the latch body 46 and is formed to include a latch-arm tooth 54. The latch-arm tooth 54 is configured to engage with the cabinet-door catch 12 to couple the cabinet-door latch 14 to the cabinet-door catch 12. As shown in FIGS. 1 and 2, the latch-arm tooth 54 engages with the catch lip 36 of the cabinet-door catch 12 to block opening of the cabinet panel 18.

The one or more alignment guides 52 are movable relative to the latch body to aid in installation of the cabinet lock 10 on the cabinet frame 16 and the cabinet panel 18 as shown in FIGS. 6 and 7. The alignment guides 52 are pivotable relative to the latch body 46 between an installation configuration and a use configuration. In the installation configuration, shown in FIG. 6, the one or more alignment guides 52 are generally parallel relative to the latch body 46 so that the alignment guides 52 can engage with the cabinet-door catch 12 during installation of the cabinet lock 10. In the use configuration, shown in FIG. 7, the one or more alignment guides 52 pivot toward the latch body 46 and are generally perpendicular relative to the latch body 46 so that the alignment guides 52 are unable to engage with the cabinet-door catch 12, such as the alignment tabs 44, during opening and closing of the cabinet door 18.

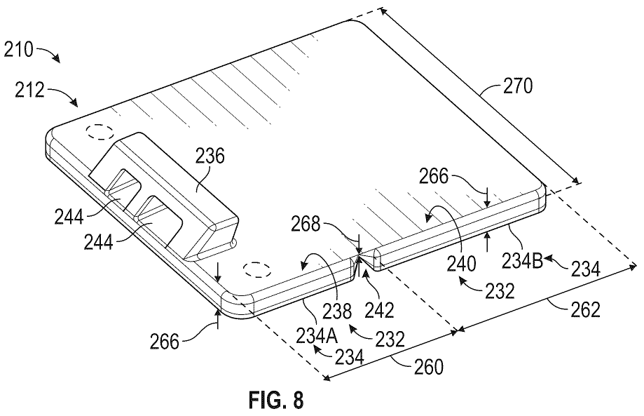

Another embodiment of a cabinet-door catch 212 is shown in FIG. 8. The cabinet-door catch 212 is configured to attach to a cabinet frame 16, 16′ as described above and is configured to engage with the cabinet-door latch 14. The cabinet-door catch 212 includes a catch body 232, an adhesive layer 234 coupled to the catch body 232 and configured to secure the cabinet-door catch 212 to the cabinet frame as described above, and a catch lip 236 coupled to the catch body 232 and configured to engage selectively with the cabinet-door latch 214 when the cabinet door is closed as described above. In the illustrative embodiment, the catch lip 236 extends generally perpendicular relative to at least a portion of the catch body 232. The catch lip 236 may be formed to include one or more alignment slots 244 configured to engage with an alignment tool during installation.

The catch body 232 includes a pair of body panels 238, 240 and a hinge 242 interconnecting the body panels 238, 240 as shown in FIG. 8. The first body panel 238 is coupled to the catch lip 236 and a first section 234A of the adhesive layer 234. The second body panel 240 is spaced apart from the first body panel 238 and is coupled to a second section 234B of the adhesive layer 234. The hinge 242, also referred to as a living hinge 242, allows for the second body panel 240 to be adjusted or posed and installed in multiple directions relative to the first body panel 238.

The first body panel 238 and the second body panel 240 each have a common width 270 as shown in FIG. 8. The first body panel has a first length 260 and the second body panel 240 has a second length 262 greater than the first length 260. The lengths 260, 262 can be the same as lengths 60, 62 described above with reference to cabinet-door catch 12. The first and second body panels 238, 240 have a first thickness 266 and the hinge 242 has a second thickness 268 less than the first thickness 266 to provide a predetermined bend line for the catch body 232 at the hinge 242.

1. A cabinet lock comprising
a cabinet-door latch configured to be fixed to a cabinet panel for movement with the cabinet panel between a closed position blocking access to a cabinet opening and an opened position exposing the cabinet opening,
a cabinet-door catch configured to be attached to a cabinet frame bordering the cabinet opening that is closed by the cabinet panel, the cabinet-door catch including a catch body, an adhesive layer coupled to the catch body and configured to secure the cabinet-door catch to the cabinet frame, and a catch lip coupled to the catch body and configured to engage selectively with the cabinet-door latch when the cabinet panel is closed to block the cabinet panel from opening,
wherein the catch body includes a first body panel coupled to the catch lip, a second body panel spaced apart from the first body panel and the catch lip, and a hinge interconnecting the first body panel and the second body panel of the catch body so that the cabinet-door catch can be attached to the cabinet frame in a first configuration in which the first and second body panels of the catch body are arranged to lie along a common plane, and in a second configuration in which the catch body is bent about the living hinge so that the first and second body panels of the catch body are arranged to lie along respective planes at an angle to one another.

2. The cabinet lock of claim 1, wherein the hinge has a first thickness and the first and second body panels have a second thickness greater than the first thickness.

3. The cabinet lock of claim 1, wherein the adhesive layer includes a first adhesive pad coupled to the first body panel and a second adhesive pad coupled to the second body panel.

4. The cabinet lock of claim 1, wherein the first body panel has a first length and the second body panel has a second length greater than the first length.

5. The cabinet lock of claim 4, wherein the first length is less than or equal to 0.6 inches and the second length is greater than or equal to 1.3 inches.

6. The cabinet lock of claim 1, wherein the first body panel has a first width and the second body panel has a second width less than the first width.

7. A cabinet lock comprising
a latch and
a catch configured to engage selectively with the latch to block movement of the latch away from the catch, the catch including a catch body and a catch lip coupled to the catch body,
wherein the catch body includes a first body panel, a second body panel spaced apart from the first body panel, and a hinge interconnecting the first body panel and the second body panel of the catch body, and
wherein the first body panel and the second body panel are pivotable relative to one another about a hinge axis provided by the hinge from a first configuration in which the first and second body panels of the catch body are substantially parallel with one another, to a second configuration in which the first and second body panels of the catch body are arranged to lie at an angle to one another.

8. The cabinet lock of claim 7, wherein the hinge has a first thickness and the first and second body panels have a second thickness greater than the first thickness.

9. The cabinet lock of claim 7, further comprising an adhesive layer having a first adhesive pad coupled to the first body panel and a second adhesive pad coupled to the second body panel.

10. The cabinet lock of claim 7, wherein the first body panel has a first length and the second body panel has a second length greater than the first length.

11. The cabinet lock of claim 10, wherein the first length is less than or equal to 0.6 inches and the second length is greater than or equal to 1.3 inches.

12. The cabinet lock of claim 7, wherein the first body panel has a first width and the second body panel has a second width less than the first width.

13. A cabinet lock comprising:
a cabinet-door latch configured to be fixed to a cabinet panel for movement with the cabinet panel between a closed position blocking access to a cabinet opening and an opened position exposing the cabinet opening, and
a cabinet-door catch configured to engage selectively with the cabinet-door latch to block the cabinet panel from moving from the closed position to the opened position,
wherein the cabinet-door catch includes means for attaching to a first cabinet frame in a first configuration to establish a first attachment interface along a common plane with a surface of the first cabinet frame and to a second cabinet frame in a second configuration to establish a second attachment interface along a first plane with a first portion of the second cabinet frame and a second plane with a second portion of the second cabinet frame so that shear resistance to a pull-out force acting on the cabinet-door catch by the cabinet-door latch is maximized when the cabinet-door catch is attached to the first cabinet frame in the first configuration and to the second cabinet frame in the second configuration.

14. The cabinet lock of claim 13, wherein the means includes a catch body, an adhesive layer coupled to the catch body and configured to secure the cabinet-door catch to the cabinet frame, and hinge separating the catch body and the adhesive layer into: (i) a first body panel and a first adhesive layer coupled to the first body panel, and (ii) a second body panel and a second adhesive layer coupled to the second body panel.

15. The cabinet lock of claim 14, wherein the hinge has a first thickness and the first and second body panels have a second thickness greater than the first thickness.

16. The cabinet lock of claim 14, wherein the first body panel has a first length and the second body panel has a second length greater than the first length.

17. The cabinet lock of claim 16, wherein the first length is less than or equal to 0.6 inches and the second length is greater than or equal to 1.3 inches.

18. The cabinet lock of claim 14, wherein the first body panel has a first width and the second body panel has a second width less than the first width.

19. The cabinet lock of claim 14, wherein the catch body is formed without any through holes.

20. The cabinet lock of claim 14, wherein the catch body has a total length in the first configuration of at least 1.5 inches.
